(19) United States
(12) Patent Application Publication
(10) Pub. No.: US 2013/0258200 A1
(43) Pub. Date: Oct. 3, 2013

(54) VIDEO PROCESSOR AND VIDEO PROCESSING METHOD

(71) Applicant: KABUSHIKI KAISHA TOSHIBA, Tokyo (JP)

(72) Inventors: Takero KOBAYASHI, Akishima (JP); Toshihiro MOROHOSHI, Kawasaki (JP); Atsushi NAKAMURA, Hino (JP); Shinzo MATSUBARA, Akishima (JP); Akinori KOMAKI, Ome (JP)

(73) Assignee: KABUSHIKI KAISHA TOSHIBA, Tokyo (JP)

(21) Appl. No.: 13/736,739

(22) Filed: Jan. 8, 2013

(30) Foreign Application Priority Data
Mar. 29, 2012 (JP) 2012-077999

(51) Int. Cl. H04N 9/67

(52) U.S. Cl. CPC H04N 9/67
USPC 348/660

(57) ABSTRACT

According to one embodiment, a video processor includes an input module and a display controller. The input module is configured to input a plurality of first video signals compliant with a video having a first resolution, and to be able to input a second video signal compliant with a video having a second resolution higher than the first resolution instead of at least one of the first video signals. The display controller is configured to perform control to display the input first video signals in domains into which a display screen compliant with the second resolution is divided. The display controller is configured to perform control to display the input second video signal on the whole display screen.

### CROSS-REFERENCE TO RELATED APPLICATIONS

This application is based upon and claims the benefit of priority from prior Japanese Patent Application No. 2012-077999, filed Mar. 29, 2012, the entire contents of which are incorporated herein by reference.

### FIELD

Embodiments described herein relate generally to a video processor, such as a digital television broadcasting receiver, and a video processing method.

### BACKGROUND

As is well known, a digital television broadcasting receiver currently in widespread home use is provided with a video display panel having a resolution known as full high definition (FHD), which includes 1920 pixels in a horizontal direction and 1080 pixels in a vertical direction.

Recently, there has also been developed a video display panel having a resolution four times the FHD, namely, what is called quad (Q) FHD, which comprises 3840 pixels in the horizontal direction and 2160 pixels in the vertical direction. In the QFHD-compliant video display panel, FHD-compliant video can be displayed in each of four domains into which the display screen is divided.

Therefore, a usage mode in which one QFHD-compliant video is displayed on the whole display screen and a usage mode in which multi-screen display of up to four FHD-compliant video is performed on the display screen can be selected in the QFHD-compliant video display panel.

However, the technology of selectively displaying the QFHD-compliant video or the FHD-compliant video using the QFHD-compliant video display panel is still in a developmental stage, and there is a strong demand to improve the usability to an extent enabling practical use.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block configuration diagram illustrating an example of HDMI-standard signal transmission between a digital television broadcasting receiver according to an embodiment and a source device;

FIG. 2 is a block configuration diagram schematically illustrating an example of a signal processing system of the digital television broadcasting receiver of the embodiment;

FIG. 3 is an outline view illustrating an example of a remote controller used in the digital television broadcasting receiver of the embodiment;

FIG. 4 is a block configuration diagram illustrating an example of a selection controller included in the digital television broadcasting receiver of the embodiment;

FIG. 5 is a view illustrating an example of resolution of a video display panel included in the digital television broadcasting receiver of the embodiment;

FIG. 6 is a view illustrating an example of a video display mode displayed by the digital television broadcasting receiver of the embodiment;

FIGS. 7A, 7B, 7C and 7D are views illustrating another example of the video display mode displayed by the digital television broadcasting receiver of the embodiment;

FIGS. 8A, 8B, 8C, 8D, 8E and 8F are views illustrating still another example of the video display mode displayed by the digital television broadcasting receiver of the embodiment;

FIGS. 9A, 9B, 9C and 9D are views illustrating still another example of the video display mode displayed by the digital television broadcasting receiver of the embodiment;

FIG. 10 is a view illustrating still another example of the video display mode displayed by the digital television broadcasting receiver of the embodiment;

FIG. 11 is a flowchart illustrating an example of a main processing operation performed by the digital television broadcasting receiver of the embodiment;

FIG. 12 is a view illustrating an example of a display mode setting screen displayed by the digital television broadcasting receiver of the embodiment;

FIG. 13 is a flowchart illustrating another example of the main processing operation performed by the digital television broadcasting receiver of the embodiment; and

FIGS. 14A and 14B are views illustrating examples of a priority selecting screen and a priority setting screen, which are displayed by the digital television broadcasting receiver of the embodiment.

### DETAILED DESCRIPTION

Various embodiments will be described hereinafter with reference to the accompanying drawings.

In general, according to one embodiment, a video processor comprises an input module and a display controller. The input module is configured to input a plurality of first video signals compliant with a video having a first resolution, and to be able to input a second video signal compliant with a video having a second resolution higher than the first resolution instead of at least one of the first video signals. When only the first video signals are input to the input module, the display controller is configured to perform control to display the input first video signals in domains into which a display screen compliant with the second resolution is divided. When the second video signal is input to the input module, the display controller is configured to perform control to display the input second video signal on the whole display screen.

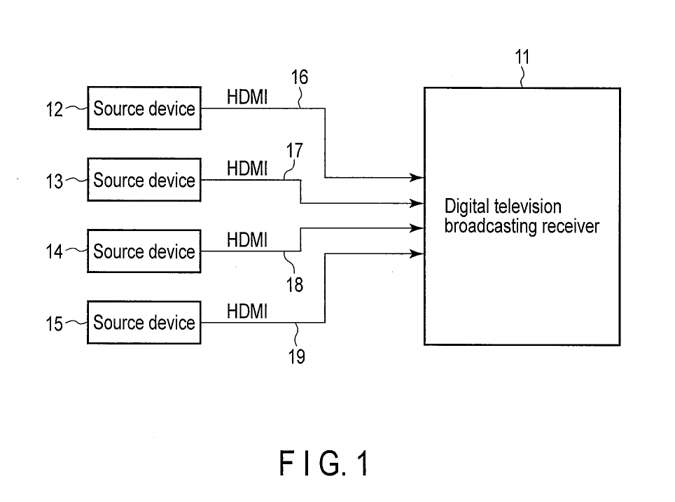

Referring to FIG. 1, a digital television broadcasting receiver 11 can receive digital television broadcasting to display a video or play back an audio. It is assumed that the digital television broadcasting receiver 11 includes a video display panel compliant with QFHD resolution.

A plurality of (in FIG. 1, four) source devices 12, 13, 14, and 15 are connected to the digital television broadcasting receiver 11 through high definition multimedia interface (HDMI) cables 16, 17, 18, and 19, such that a signal can be transmitted by a system pursuant to the HDMI 1.4a standard.

Therefore, the digital television broadcasting receiver 11 can acquire information on the video or audio from the source devices 12 to 15, and perform video display or audio playback. In such cases, for example, it is assumed that the source devices 12 to 15 are an optical-disk record and playback device, a video camera, and a personal computer (PC).

At this point, in the digital television broadcasting receiver 11, it is assumed that an input/output port connected to the source device 12 includes a function of selectively inputting a video signal compliant with the QFHD resolution and a video signal compliant with FHD resolution, and that input/output ports connected to the source devices 13 to 15 include a function of inputting video signal compliant with the FHD resolution.

When at least one of the source devices 12 to 15 supplies only FHD-compliant video signal, the digital television broadcasting receiver 11 functions so as to perform multi-screen display of FHD-compliant video obtained from the source devices 12 to 15 on a video display panel, as described in detail below.

When the source device 12 supplies a QFHD-compliant video signal, the digital television broadcasting receiver 11 functions so as to perform whole screen display of a QFHD-compliant video obtained from the source device 12 on the video display panel irrespective of the FHD-compliant video signals obtained from the source devices 13 to 15.

Thus, a video display mode can automatically be set according to the resolution of the input video to improve the usability to the extent sufficient for practical use such that the multi-screen display of the FHD-compliant video is performed when the source devices 12 to 15 supply only the FHD-compliant video signals, and such that the whole screen display of the QFHD-compliant video is performed when the source device 12 supplies the QFHD-compliant video signal.

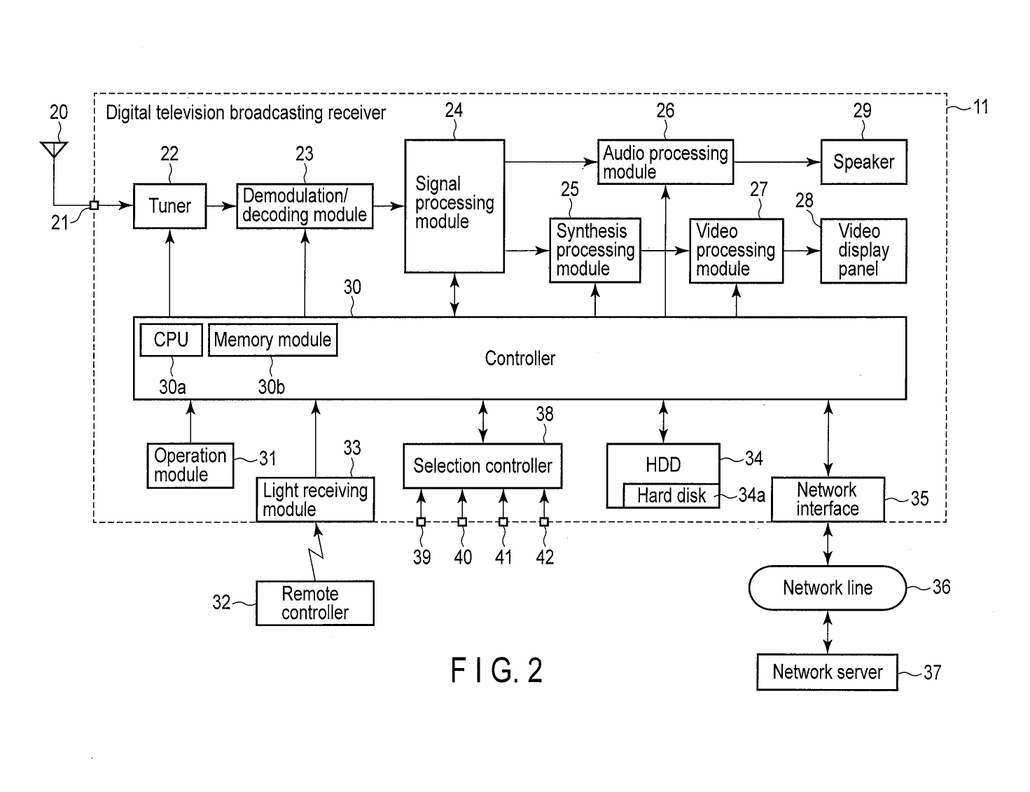

FIG. 2 schematically illustrates a signal processing system of the digital television broadcasting receiver 11. A digital television broadcasting signal received by an antenna 20 is supplied to a tuner 22 through an input terminal 21, thereby selecting the broadcasting signal of a desired channel. The broadcasting signal selected by the tuner 22 is supplied to a demodulation/decoding module 23, and restored to a digital video signal, an audio signal and the like. Then the digital video signal, the audio signal and the like are output to a signal processing module 24.

The signal processing module 24 performs predetermined digital signal processing to the digital video signal and the audio signal, which are supplied from the demodulation/decoding module 23. The signal processing module 24 outputs a digital video signal to a synthesis processing module 25, and outputs a digital audio signal to an audio processing module 26.

The synthesis processing module 25 superimposes an on-screen display (OSD) signal on the digital video signal supplied from the signal processing module 24, and outputs the digital video signal. The digital video signal output from the synthesis processing module 25 is supplied to a video processing module 27. The video processing module 27 converts the digital video signal into an analog video signal having a format that can be displayed on a QFHD-compliant video display panel 28. Then the analog video signal is supplied to the video display panel 28 and used for the video display.

The audio processing module 26 converts the input digital audio signal into an analog audio signal having a format that can be played back by a speaker 29. The analog audio signal output from the audio processing module 26 is supplied to the speaker 29 and used for the audio playback.

A controller 30 totally controls various operations including the receiving operations of the digital television broadcasting receiver 11. The controller 30 incorporates a Central Processing Unit (CPU) 30a therein. The controller 30 controls each module of the digital television broadcasting receiver 11 such that operation content is reflected by receiving operation information from an operation module 31 provided in a main body of the digital television broadcasting receiver 11 or operation information, which is transmitted from a remote controller 32 and received by a light receiving module 33.

In this case, the controller 30 uses a memory module 30b. The memory module 30b mainly includes a Read Only Memory (ROM) in which a control program executed by the CPU 30a is stored, a Random Access Memory (RAM) that provides a work area to the CPU 30a, and a nonvolatile memory in which various pieces of setting information, control information and the like are stored.

A Hard Disk Drive (HDD) 34 is connected to the controller 30. Based on a use operation of the operation module 31 or the remote controller 32, the controller 30 supplies the digital video signal and the digital audio signal, which are obtained from the signal processing module 24, to the HDD 34, and encodes the digital video signal and the digital audio signal into a predetermined recording format, and records the digital video signal and the digital audio signal in a hard disk 34a.

Based on the use operation of the operation module 31 or the remote controller 32, the controller 30 reads the digital video signal and the digital audio signal from the hard disk 34a using the HDD 34, decodes the digital video signal and the digital audio signal, and supplies the digital video signal and the digital audio signal to the signal processing module 24, whereby the digital video signal and the digital audio signal are used for the video display and the audio playback.

A network interface 35 is connected to the controller 30. An external network line 36 is connected to the network interface 35. A network server 37 is connected to the network line 36 in order to use a communication function through the network line 36 to provide various services.

Therefore, based on the use operation of the operation module 31 or the remote controller 32, the controller 30 is configured to be able to access the network server 37 through the network interface 35 and the network line 36 to conduct information communication, and to use the services provided by the network server 37.

A selection controller 38 is connected to the controller 30. The selection controller 38 is connected to input/output ports 39, 40, 41 and 42. The source devices 12 to 15 are connected to the input/output ports 39 to 42 through HDMI cables 16 to 19.

In response to the control of the controller 30 based on the use operation of the operation module 31 or the remote controller 32, the selection controller 38 functions so as to selectively supply the video signals or the audio signals, which are supplied to the input/output ports 39 to 42 from the source devices 12 to 15, to the signal processing module 24.

Specifically, when only the FHD-compliant video signal is supplied to at least one of the input/output ports 39 to 42, the selection controller 38 functions so as to derive the FHD-compliant video signals, which are supplied to the input/output ports 39 to 42, to the signal processing module 24. Therefore, after the FHD-compliant video signals are processed by the synthesis processing module 25 and the video processing module 27, the video display panel 28 performs the multi-screen display of the FHD-compliant video signals.

When only the QFHD-compliant video signal is supplied to the input/output port 39, the selection controller 38 functions so as to derive the QFHD-compliant video signal, which is supplied to the input/output port 39, to the signal processing module 24. Therefore, after the QFHD-compliant video signal is processed by the synthesis processing module 25 and the video processing module 27, the video display panel 28 performs the whole screen display of the QFHD-compliant video signal.

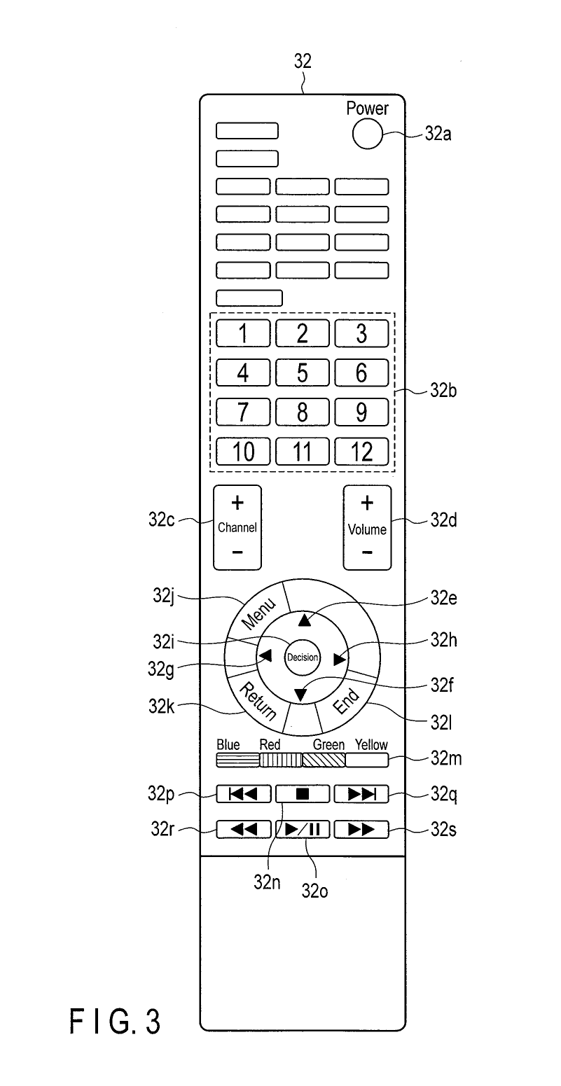

FIG. 3 illustrates an appearance of the remote controller 32. The remote controller 32 mainly includes a power key 32a, numerical keys 32b, a channel change key 32c, a volume key 32d, a cursor upward moving key 32e, a cursor downward moving key 32f, a cursor leftward moving key 32g, a cursor rightward moving key 32h, a decision key 32i, a menu key 32j, a return key 32k, an end key 32l, and color keys 32m of four colors (blue, red, green, and yellow).

The remote controller 32 also includes a playback stop key 32n, playback/pause key 32o, a reverse-direction skip key 32p, a forward-direction skip key 32q, a fast-rewind key 32r, a fast-forward key 32s, and the like. The playback, the stop, and the pause can be performed to the HDD 34 by operating the playback stop key 32n or the playback/pause key 32o of the remote controller 32.

What is called a reverse-direction skip or a forward-direction skip, in which the video, audio data or the like read from the hard disk 34a with the HDD 34 can be skipped by a given amount in the reverse or forward direction of the playback direction, can be performed by operating the reverse-direction skip key 32p or the forward-direction skip key 32q of the remote controller 32.

What is called fast-rewind playback or fast-forward playback, in which the video, audio data or the like read from the hard disk 34a with the HDD 34 can continuously be played back at high speed in the reverse or forward direction of the playback direction, can be performed by operating the fast-rewind key 32r, the fast-forward key 32s or the like of the remote controller 32.

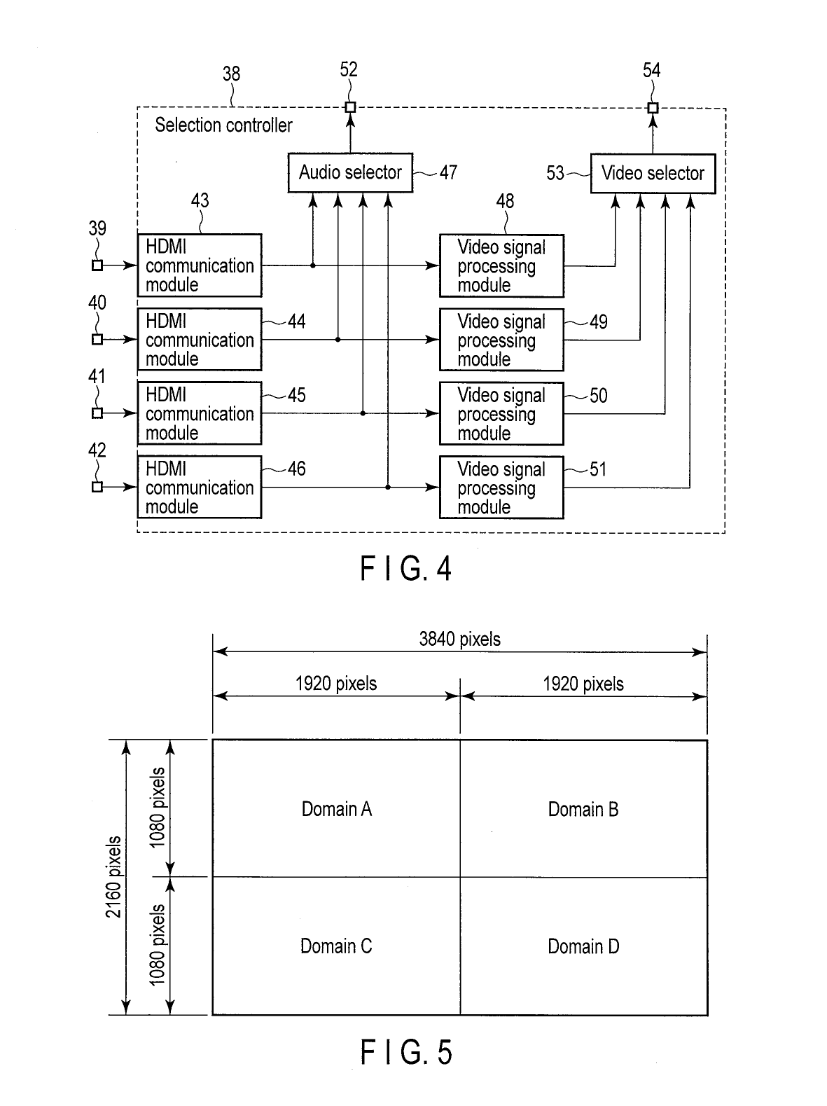

FIG. 4 illustrates an example of the selection controller 38. An HDMI communication module 43 receives the video and audio signals, which are output from the source device 12 and supplied to the input/output port 39 through the HDMI cable 16. The HDMI communication module 43 includes a function of receiving the video signal having the QFHD resolution in addition to the video signal having the FHD resolution or less, and includes a function of sending back the possession of the receiving function in response to an inquiry from the source device 12 using extended display identification data (EDID) information.

HDMI communication modules 44, 45, and 46 receive the video and audio signals, which are output from the source devices 13 to 15 and supplied to the input/output ports 40 to 42 through the HDMI cables 17 to 19, respectively. Each of the HDMI communication modules 44 to 46 includes the function of receiving the video signal having the FHD resolution or less, and includes the function of sending back the possession of the receiving function in response to the inquiry from the source devices 13 to 15 using the EDID information.

The signals supplied to the HDMI communication modules 43 to 46 are supplied to an audio selector 47, and also supplied to video signal processing modules 48, 49, 50, and 51, respectively. The audio selector 47 takes out the audio signals from of the input signals, and selects one audio signal under the control of the controller 30. The audio signal selected by the audio selector 47 is output from an output terminal 52, and supplied to the signal processing module 24 through the controller 30. Therefore, the audio signal is used for the audio playback.

The video signal processing modules 48 to 51 take out the video signals from the input signals and supply the video signals to a video selector 53. The video selector 53 selects at least one of the video signals from the input video signals under the control of the controller 30. The video signal selected by the video selector 53 is output from an output terminal 54, and supplied to the signal processing module 24 through the controller 30. Therefore, the video signal is used for the video display.

A main operation, which is performed by the digital television broadcasting receiver 11 having the above configuration when the controller 30 performs the video display and the audio playback based on the outputs of the source devices 12 to 15, will be described below. As described above, the video display panel 28 of the digital television broadcasting receiver 11 is compliant with the QFHD resolution.

As illustrated in FIG. 5, the video display panel 28 includes a display screen having 3840 pixels in the horizontal direction and 2160 pixels in the vertical direction. Therefore, in the QFHD-compliant video display panel 28, the multi-screen display of the FHD-compliant video (each of which has 1920 pixels in the horizontal direction and 1080 pixels in the vertical direction) can be performed in domains A, B, C, and D into which the display screen of the video display panel 28 is divided.

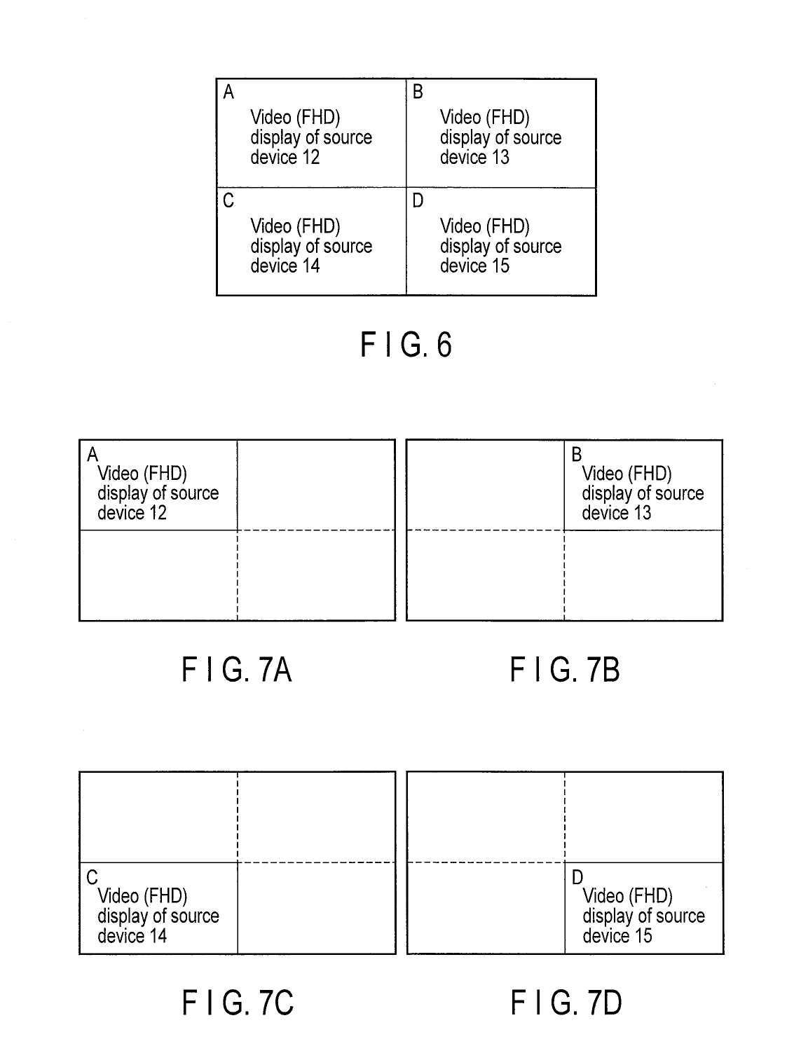

Accordingly, for example, when all the source devices 12 to 15 output the FHD-compliant video signals, as illustrated in FIG. 6, the controller 30 performs control such that the multi-screen display is performed while the FHD-compliant video obtained from the source devices 12 to 15 are respectively allocated to the domains A to D into which the display screen is divided.

When only the source device 12 outputs the FHD-compliant video signal, as illustrated in FIG. 7A, the controller 30 performs control such that the FHD-compliant video obtained from the source device 12 is displayed on the display screen while allocated to the domain A in the domains A to D into which the display screen is divided.

Similarly, when only the source device 13 outputs the FHD-compliant video signal, as illustrated in FIG. 7B, the controller 30 performs control such that the FHD-compliant video obtained from the source device 13 is displayed on the display screen while allocated to the domain B in the domains A to D into which the display screen is divided.

Similarly, when only the source device 14 outputs the FHD-compliant video signal, as illustrated in FIG. 7C, the controller 30 performs control such that the FHD-compliant video obtained from the source device 14 is displayed on the display screen while allocated to the domain C in the domains A to D into which the display screen is divided.

Similarly, when only the source device 15 outputs the FHD-compliant video signal, as illustrated in FIG. 7D, the controller 30 performs control such that the FHD-compliant video obtained from the source device 15 is displayed on the display screen while allocated to the domain D in the domains A to D into which the display screen is divided.

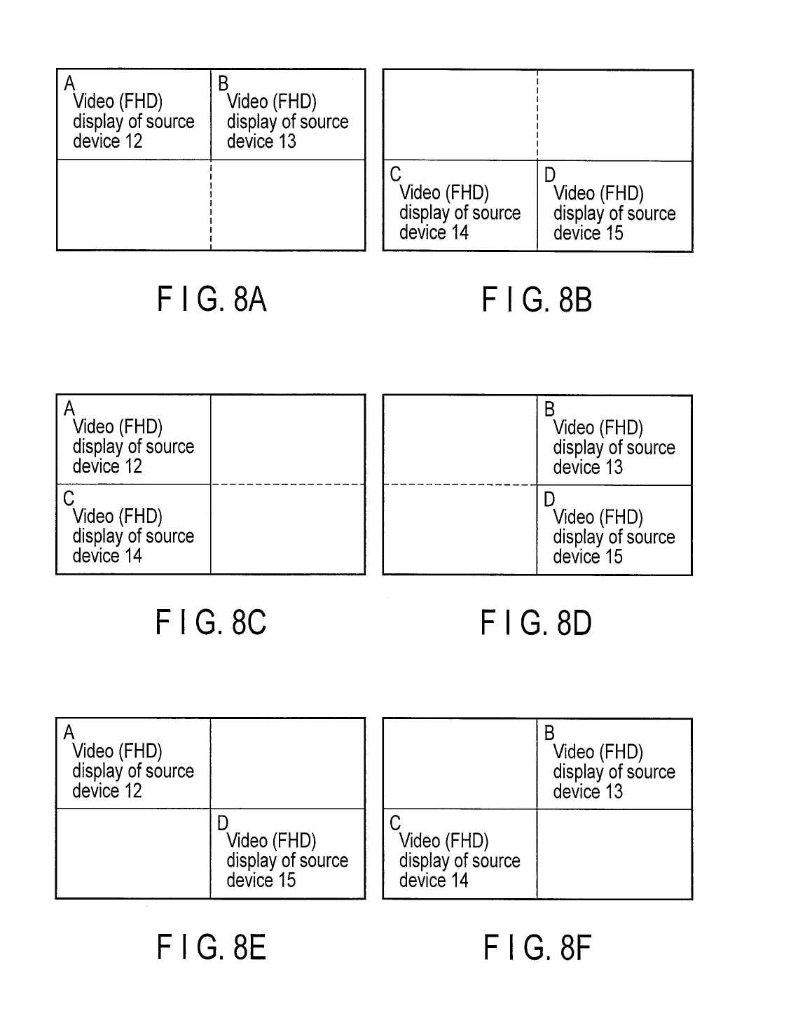

When only the source devices 12 and 13 output the FHD-compliant video signals, as illustrated in FIG. 8A, the controller 30 performs control such that the multi-screen display is performed while the FHD-compliant video obtained from the source devices 12 and 13 are allocated to the domains A and B in the domains A to D into which the display screen is divided.

Similarly, when only the source devices 14 and 15 output the FHD-compliant video signals, as illustrated in FIG. 8B, the controller 30 performs control such that the multi-screen display is performed while the FHD-compliant video obtained from the source devices 14 and 15 are allocated to the domains C and D in the domains A to D into which the display screen is divided.

Similarly, when only the source devices 12 and 14 output the FHD-compliant video signals, as illustrated in FIG. 8C, the controller 30 performs control such that the multi-screen display is performed while the FHD-compliant video obtained from the source devices 12 and 14 are allocated to the domains A and C in the domains A to D into which the display screen is divided.

Similarly, when only the source devices 13 and 15 output the FHD-compliant video signals, as illustrated in FIG. 8D, the controller 30 performs control such that the multi-screen display is performed while the FHD-compliant video obtained from the source devices 13 and 15 are allocated to the domains B and D in the domains A to D into which the display screen is divided.

Similarly, when only the source devices 12 and 15 output the FHD-compliant video signals, as illustrated in FIG. 8E, the controller 30 performs control such that the multi-screen display is performed while the FHD-compliant video obtained from the source devices 12 and 15 are allocated to the domains A and D in the domains A to D into which the display screen is divided.

Similarly, when only the source devices 13 and 14 output the FHD-compliant video signals, as illustrated in FIG. 8F, the controller 30 performs control such that the multi-screen display is performed while the FHD-compliant video obtained from the source devices 13 and 14 are allocated to the domains B and C in the domains A to D into which the display screen is divided.

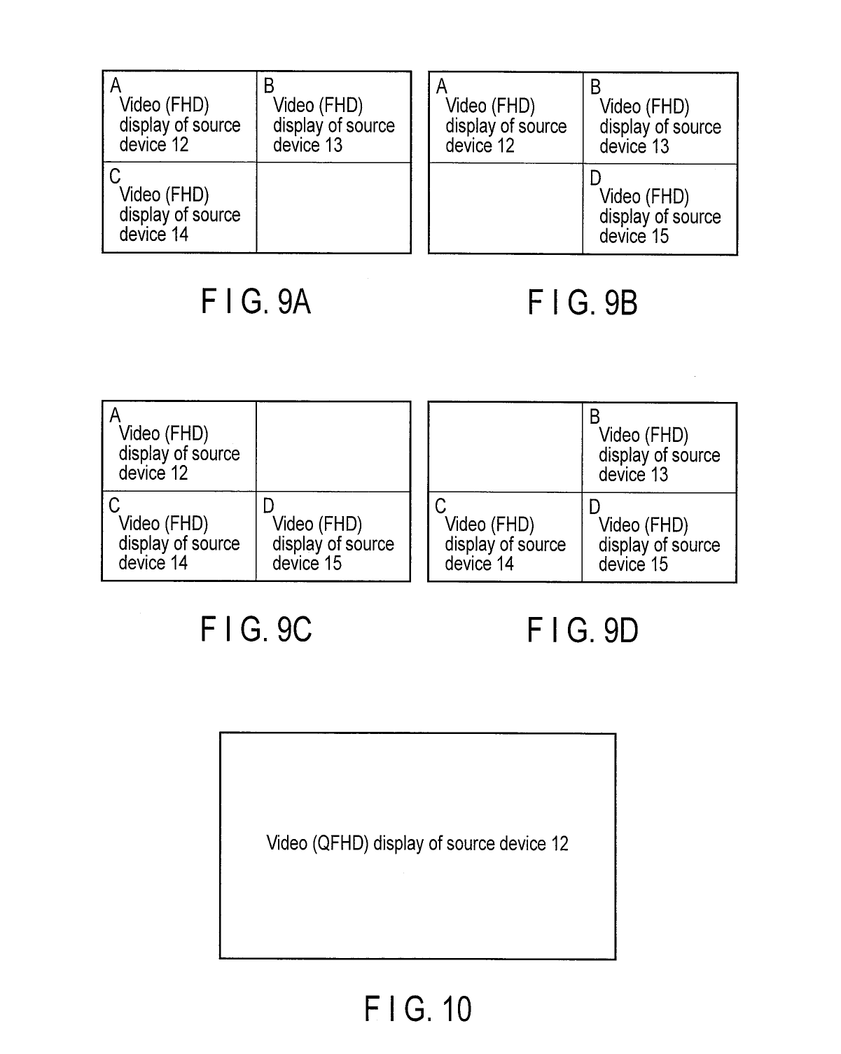

When only the source devices 12, 13, and 14 output the FHD-compliant video signals, as illustrated in FIG. 9A, the controller 30 performs control such that the multi-screen display is performed while the FHD-compliant video obtained from the source devices 12, 13, and 14 are allocated to the domains A, B, and C in the domains A to D into which the display screen is divided.

Similarly, when only the source devices 12, 13, and 15 output the FHD-compliant video signals, as illustrated in FIG. 9B, the controller 30 performs control such that the multi-screen display is performed while the FHD-compliant video obtained from the source devices 12, 13, and 15 are allocated to the domains A, B, and D in the domains A to D into which the display screen is divided.

Similarly, when only the source devices 12, 14, and 15 output the FHD-compliant video signals, as illustrated in FIG. 9C, the controller 30 performs control such that the multi-screen display is performed while the FHD-compliant video obtained from the source devices 12, 14, and 15 are allocated to the domains A, C, and D in the domains A to D into which the display screen is divided.

Similarly, when only the source devices 13, 14, and 15 output the FHD-compliant video signals, as illustrated in FIG. 9D, the controller 30 performs control such that the multi-screen display is performed while the FHD-compliant video obtained from the source devices 13, 14, and 15 are allocated to the domains B, C, and D in the domains A to D into which the display screen is divided.

When the source device 12 supplies the QFHD-compliant video signal, as illustrated in FIG. 10, the controller 30 performs control such that the QFHD-compliant video obtained from the source device 12 is displayed on the whole display screen irrespective of presence or absence of the FHD-compliant video signals from the source devices 13 to 15.

In one of the display modes in FIGS. 7A to 9D, namely, in the display mode in which the video display is performed to one to three domains in the domains A to D into which the display screen is divided, a black screen is displayed in the domain in which the video is not displayed, namely, the domain to which the FHD-compliant video signal is not supplied from each of the source devices 12 to 15, so that the user can clearly recognize the domain to which the video is not supplied. Therefore, the usability is improved to the extent sufficient for practical use.

To summarize the operation of the controller 30, when at least one of the source devices 12 to 15 supplies only the FHD-compliant video signal, the video is displayed in the divided domain of the video display panel 28 as illustrated in FIGS. 6 to 9D. When the source device 12 supplies the QFHD-compliant video signal, as illustrated in FIG. 10, the QFHD-compliant video is displayed on the whole screen of the video display panel 28 irrespective of the video from the source devices 13 to 15.

That is, when the source device 12 supplies the QFHD-compliant video signal while one of the video displays in FIGS. 6 to 9D is performed, the controller 30 performs control such that the QFHD-compliant video is displayed on the whole screen of the video display panel 28 as illustrated in FIG. 10. On the other hand, when the supply of the QFHD-compliant video signal from the source device 12 is stopped while the QFHD-compliant video in FIG. 10 is displayed, the controller 30 performs control such that at least one of the FHD-compliant video is displayed on the video display panel 28 as illustrated in FIGS. 6 to 9D.

In this case, by reading the information on the resolution from the video signal supplied to the HDMI communication module 43, the controller 30 determines whether the source device 12 supplies the QFHD-compliant video signal, and automatically switches the video display mode.

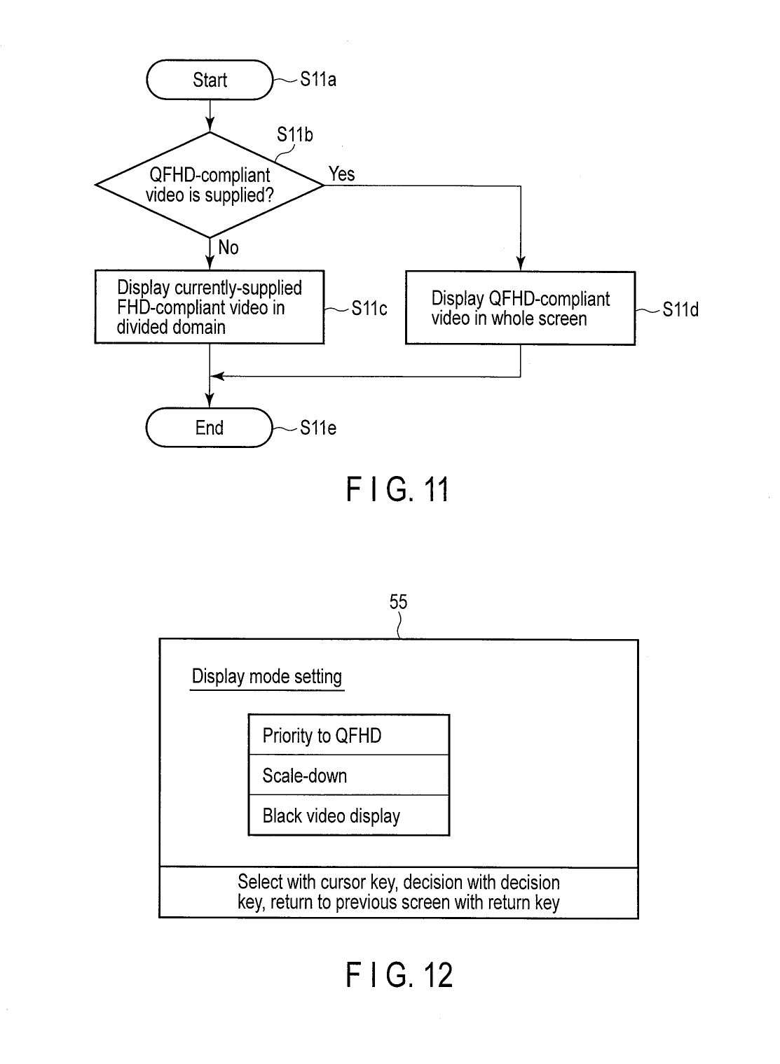

FIG. 11 is a flowchart illustrating an example of the video-display-mode switching operation performed by the controller 30 as described above. When the processing is started (Step S11a), the controller 30 determines whether the QFHD-compliant video signal is supplied to the HDMI communication module 43 in Step S11b.

When the QFHD-compliant video signal is not supplied (NO in Step S11b), the controller 30 performs control such that at least one of the FHD-compliant video supplied to the HDMI communication modules 43 to 46 is displayed on the divided domain of the video display panel 28 in Step S11c. Then the processing is ended (Step S11e).

When the QFHD-compliant video signal is supplied (YES in Step S11b), the controller 30 performs control such that the QFHD-compliant video supplied to the HDMI communication module 43 is displayed on the whole screen of the video display panel 28 in Step S11d. Then the processing is ended (Step S11e).

According to the embodiment, the display mode of the video on the video display panel 28 is automatically set according to the resolution of the input video, so that the usability can be improved to the extent sufficient for practical use.

The function of receiving the video signal having the QFHD resolution is provided to the HDMI communication module 43 of the selection controller 38, so that the QFHD-compliant video signal can be input to the input/output port 39 in the input/output ports 39 to 42 to which the FHD-compliant video signals used to perform the multi-screen display are supplied.

Therefore, it is not necessary to provide another port to input the QFHD-compliant video signal in addition to the input/output ports 39 to 42 to which the FHD-compliant video signals are supplied, and an advantageous configuration is implemented.

In the embodiment, the video signal having a resolution different from that of the video signal supplied to the input/output ports 40 to 42 can be supplied to the input/output port 39 in the input/output ports 39 to 42. Alternatively, the video signal having a resolution and a frequency band, which are different from those of the video signal supplied to the input/output ports 40 to 42, may be supplied to the input/output port 39 in the input/output ports 39 to 42.

In the embodiment, the video display mode is automatically set in both the case that the QFHD-compliant video is displayed on the whole screen of the QFHD-compliant video display panel 28 and the case that the multi-screen display of the FHD-compliant video is performed. Alternatively, for example, the video display mode may automatically be set like the embodiment in the case that the multi-screen display of the FHD-compliant video is performed on the video display panel 28 having the resolution in which three FHD-compliant video can be displayed in the horizontal direction while three FHD-compliant video are displayed in the vertical direction and the case that one video is displayed on the whole screen of the video display panel 28.

A modification of the embodiment will be described below. In the embodiment, when the QFHD-compliant video signal is supplied, the QFHD-compliant video is automatically displayed on the whole screen. Alternatively, the user may select the display mode of the QFHD-compliant video.

The user operates the menu key 32j of the remote controller 32 to enter a plurality of kinds of menu screens having a hierarchical structure, and a display mode setting screen 55 illustrated as an example in FIG. 12 is displayed on the video display panel 28, thereby selecting the display mode with respect to the QFHD-compliant video.

Three items including “priority to QFHD”, “scale-down”, and “black video display” are displayed on the display mode setting screen 55. The user operates the cursor upward moving key 32e and the cursor downward moving key 32f of the remote controller 32 to select the desired item, and the user can operate the decision key 32i to set the display mode of the item.

In the case that “priority to QFHD” is set, as described above, the controller 30 performs control so as to implement the display mode, in which the QFHD-compliant video is preferentially displayed on the whole screen of the video display panel 28, when the QFHD-compliant video signal is supplied.

In the case that “scale-down” is set, the controller 30 performs control so as to implement the display mode, in which the QFHD-compliant video is scaled down and displayed in the divided domain A of the video display panel 28, when the QFHD-compliant video signal is supplied.

In the case that “black video display” is set, the controller 30 performs control so as to implement the display mode, in which the black screen is displayed in the divided domain A of the video display panel 28 such that the QFHD-compliant video is not displayed, when the QFHD-compliant video signal is supplied.

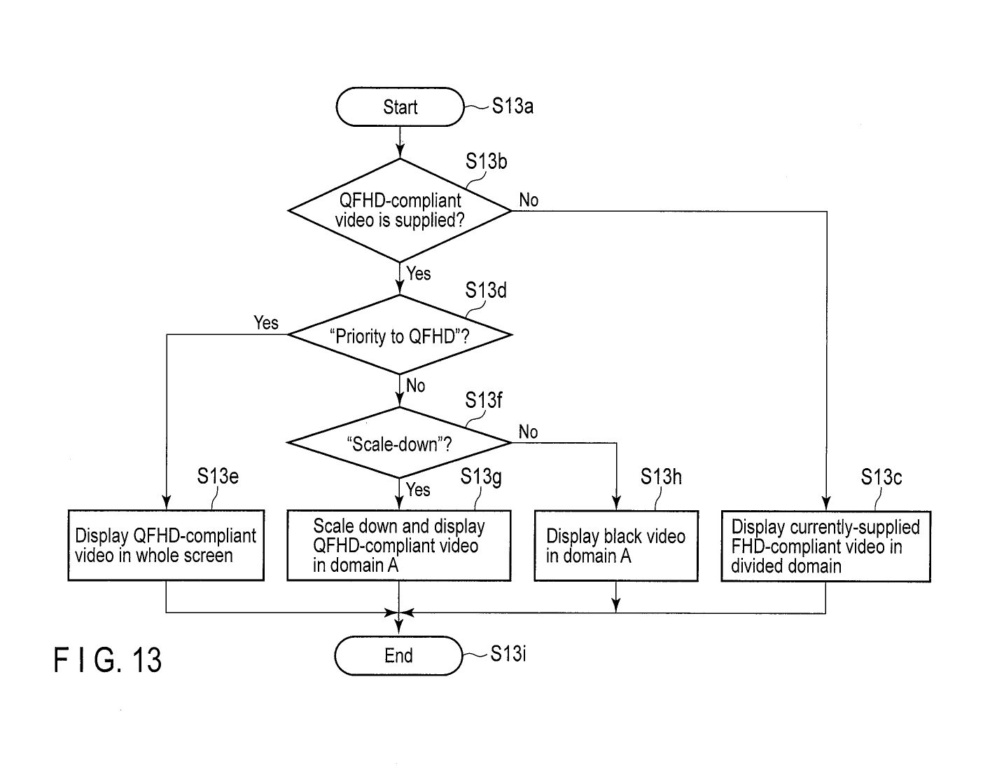

FIG. 13 is a flowchart illustrating an example of the processing operation performed by the controller 30 when the user can select the video display mode in the case that the QFHD-compliant video signal is supplied as described above. When the processing is started (Step S13a), the controller 30 determines whether the QFHD-compliant video signal is supplied to the HDMI communication module 43 in Step S13b.

When the QFHD-compliant video signal is not supplied (NO in Step S13b), the controller 30 performs control such that at least one of the FHD-compliant video currently supplied to the HDMI communication modules 43 to 46 is displayed on the divided domain of the video display panel 28 in Step S13c. Then the processing is ended (Step S13i).

When the QFHD-compliant video signal is supplied (YES in Step S13b), the controller 30 determines whether the display mode is set to “priority to QFHD” in Step S13d. When the display mode is set to “priority to QFHD” (YES in Step S13d), the controller 30 performs control such that the QFHD-compliant video supplied to the HDMI communication module 43 is displayed on the whole screen of the video display panel 28 in Step S13e. Then the processing is ended (Step S13i).

When the display mode is not set to “priority to QFHD” (NO in Step S13d), the controller 30 determines whether the display mode is set to “scale-down” in Step S13f. When the display mode is set to “scale-down” (YES in Step S13f), the controller 30 performs control such that the QFHD-compliant video supplied to the HDMI communication module 43 is scaled down and displayed in the divided domain A of the video display panel 28 in Step S13g. Then the processing is ended (Step S13i).

When the display mode is not set to “scale-down” (NO in Step S13f), the controller 30 performs control such that the black screen is displayed in the divided domain A of the video display panel 28 in order not to display the QFHD-compliant video in Step S13h. Then the processing is ended (Step S13i).

Thus, because the user can select the display mode of the QFHD-compliant video, the usability is improved to the extent sufficient for practical use.

The audio playback will be described below. When the screen display is performed only in one of the domains A to D of the video display panel 28 while only one of the source devices 12 to 15 outputs the FHD-compliant video signal as illustrated in FIGS. 7A to 7D, the controller 30 performs control so as to perform the audio playback corresponding to one displayed video.

When the whole screen display is performed on the video display panel 28 while the source device 12 outputs the QFHD-compliant video signal as illustrated in FIG. 10, the controller 30 performs control so as to perform the audio playback corresponding to one displayed video.

When the multi-screen display is performed to at least two of the domains A to D of the video display panel 28 while at least two of the source devices 12 to 15 output the FHD-compliant video signals as illustrated in FIG. 6 and FIGS. 8A to 9D, the controller 30 performs control so as to perform the audio playback corresponding to one of the displayed video.

For example, the audio that is played back when the plurality of video are displayed can be obtained by a technique of directly selecting the audio corresponding to the desired video by user operation, a technique in which a priority order is previously provided to each of the domains A to D and the audio corresponding to the video displayed in the domain having the higher priority is automatically selected, a technique in which the user provides the priority order to each of the domains A to D, a technique of setting the priority order provided to each of the domains A to D based on a listening history, and the like.

As to the technique of directly selecting the audio corresponding to the desired video by the user operation, for example, when the user successively operates the yellow color key 32m of the video display panel 28 while the multi-screen display is performed, the audio corresponding to the displayed video is successively switched in the order of the domains A, B, C, and D.

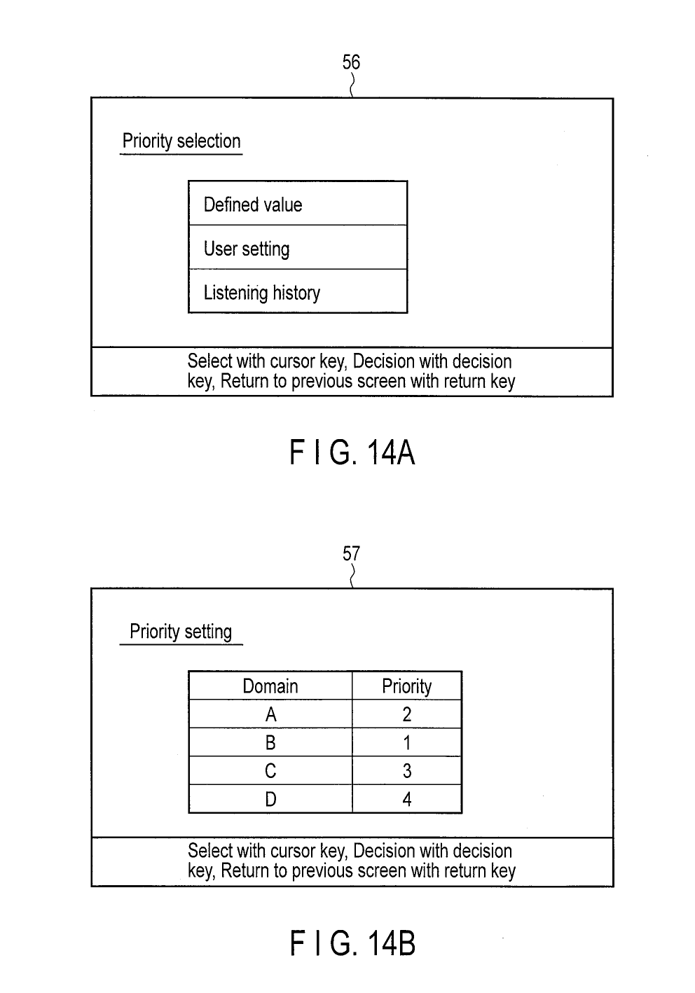

The user can select the three remaining techniques. The user operates the menu key 32j of the remote controller 32 to enter the plurality of kinds of menu screens having the hierarchical structure, and a priority selection screen 56 illustrated as an example in FIG. 14A is displayed on the video display panel 28, thereby selecting the techniques.

Three items including “defined value”, “user setting”, and “listening history” are displayed on the priority selection screen 56. The user operates the cursor upward moving key 32e and the cursor downward moving key 32f of the remote controller 32 to select the desired item, and the user can operate the decision key 32i to set the item.

In the case that “defined value” is set, the controller 30 performs control such that the audio corresponding to the video displayed in the domain having the higher priority is automatically selected based on the priority orders set to the domains A to D.

In the case that “user setting” is set, the controller 30 displays a priority setting screen 57 illustrated as an example in FIG. 14B on the video display panel 28. A field in which the priority order is input is displayed in the priority setting screen 57 according to each of the domains A, B, C, and D.

The user operates the cursor upward moving key 32e and the cursor downward moving key 32f of the remote controller 32 to select the desired domain, and the user operates the numerical key 32b to set a numerical value of the operated numerical key 32b into the field corresponding to the selected domain as the priority order. When the priority orders are set to the domains A to D, the controller 30 performs control such that the audio corresponding to the video displayed in the domain having the higher priority is automatically selected based on the priority orders set to the domains A to D.

In the case that “listening history” is set, the controller 30 sets the priority orders to the domains A to D in the descending order of the time for which the audio corresponding to the displayed video is selected. The controller 30 performs control such that the audio corresponding to the video displayed in the domain having the higher priority is automatically selected based on the priority orders set to the domains A to D.

While the QFHD-compliant video is displayed on the whole screen of the video display panel 28 as illustrated in FIG. 10, the supply of the QFHD-compliant video signal is stopped, and the whole screen display of the QFHD-compliant video is switched to the screen display of at least one of the currently-supplied FHD-compliant video. In this case, the control may be performed in what is called a last mode such that the audio of the domain selected during the screen display of at least one of the FHD-compliant video before the QFHD-compliant video signal is supplied, namely, before the whole screen display of the QFHD-compliant video is performed, is automatically selected.

In the embodiment, only the HDMI communication module 43 of the selection controller 38 includes the function of receiving the QFHD-compliant video signal. Alternatively, the HDMI communication modules 44 to 46 may have the function of receiving the QFHD-compliant video signal.

However, in such cases, it is necessary to provide a unit that sets which one of the QFHD-compliant video supplied to the HDMI communication modules 43 to 46 is displayed on the whole screen of the video display panel 28 when the QFHD-compliant video signals are supplied to the HDMI communication modules 43 to 46. In other words, it is necessary to provide a selection module in order to display the QFHD-compliant video supplied to each of the HDMI communication modules 43 to 46 on the whole screen of the video display panel 28.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video processor comprising:
an input module configured to input a plurality of first video signals compliant with a video having a first resolution, and to be able to input a second video signal compliant with a video having a second resolution higher than the first resolution in place of at least one of the first video signals; and
a display controller configured to display the first video signals in divided domains of a display screen compliant with the second resolution when only the first video signals are inputted to the input module, and to display the second video signal on the whole display screen when the second video signal is inputted to the input module.

2. The video processor of claim 1, further comprising a setting module configured to selectively set the display controller to a first display mode, in which the second video signal is displayed on the whole display screen when the second video signal is inputted to the input module.

3. The video processor of claim 2, wherein the display controller is configured to scale down the second video signal to be compliant with the first resolution and display in the divided domain of the display screen, or to display a black screen compliant with the first resolution in the divided domain of the display screen, when the setting module sets the display controller to a second display mode.

4. The video processor of claim 1, wherein the display controller is configured to display a black screen in one of the domains to which the first video signal is not inputted.

5. The video processor of claim 1, wherein the first resolution is an FHD,
the second resolution is a QFHD, and
the input module is configured to input the first and second video signals in a format pursuant to an HDMI standard.

6. The video processor of claim 1, further comprising an audio playback module configured to play back an audio corresponding to the second video signal when the second video signal is inputted to the input module.

7. The video processor of claim 6, wherein the audio playback module is configured, when a plurality of first video signals are inputted to the input module, to playback an audio corresponding to the first video signal selected by an operation, or based on a previously-set priority order.

8. A video processing method comprising:
inputting a plurality of first video signals compliant with a video having a first resolution;
inputting a second video signal compliant with a video having a second resolution higher than the first resolution in place of at least one of the plurality of first video signals;
displaying the first video signals in divided domains of a display screen compliant with the second resolution when only the first video signals are input to the input module; and
displaying the second video signal on the whole display screen when the second video signal is input to the input module.
